(19) United States
(12) Patent Application Publication
(10) Pub. No.: US 2010/0034489 A1
(43) Pub. Date: Feb. 11, 2010

(54) Gas Bearing

(76) Inventors: Mario Bechtold, Hemhofen (DE); Bernd Gromoll, Baiersdorf (DE); Stefan Nunninger, Erlangen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(21) Appl. No.: 12/084,731

(22) PCT Filed: Oct. 11, 2006
(86) PCT No.: PCT/EP2006/067265

§ 371 Date: Jul. 28, 2009

(30) Foreign Application Priority Data
Nov. 9, 2005 (DE) 10 2005 053 801.0

(51) Int. Cl. F16C 32/06

(52) U.S. Cl. 384/12

(57) ABSTRACT

Prior art discloses gas bearings, which use a stream of gas to support a piston. This is achieved by micro-nozzles in the cylinder wall of a cylindrical element. Micro-nozzles of this type are susceptible to dirt retention. According to the invention, channels that run parallel with the cylinder axis are provided on the inner face of the base element, some of the channels supplying gas via the compression chamber and the other channels being connected to the gas reservoir.

The present invention relates to a gas bearing as claimed in the preamble of claim 1.

The prior art discloses gas bearings, in particular air bearings, with a number of micro-nozzles and/or cylinder faces made of a porous material. Such gas bearings use a flow of gas to support the piston. In the case of known gas bearings, micro-nozzles with diameters of approximately 25 μm to 40 μm are present in the cylinder wall. In some instances the cylinder wall can be executed in a porous manner from sintered material. To keep losses low, these nozzles are made as small as possible. Such small nozzles are however susceptible to dirt.

In the case of large transverse forces a strong flow is required to prevent the piston making contact with the cylinder wall and the wear associated therewith. This bearing flow results in pressure-dependent losses. This is critical in the case of self-supplying compressor gas bearings, as the compressive pressure in the operating region can fluctuate for example between 3 bar and 12 bar and significant flow losses therefore have an adverse effect on efficiency at high compressive pressures.

The laser honing of the boundary faces of oil bearings is also known. In this process paths are introduced into the surface after the surface has been machined. In the case of oil bearings these paths reduce friction by up to 50%. Surface machining is therefore already used here to introduce channels into the cylinder surface and to use them to guide the oil.

On this basis the object of the invention is to create an improved gas bearing. This known surface technology is also used to achieve efficient gas guidance.

According to the invention the object is achieved by the features of claim 1. Advantageous developments are set out in the subclaims.

The subject matter of the invention is a gas bearing with channels on the walls of the elements, it being possible to achieve loss reduction by the guidance of the gas in the elements and with a counterflow principle advantageously being used to reduce the mass flow and to guide the bearing gas back into the compression chamber.

With the invention the gas is guided specifically utilizing the dead volume, in other words residual gas in the compression chamber, for gas support with little loss, as channels with or without nozzles are present on the cylinder wall or even on the piston. The channels can be continuous or can be executed over part of the cylinder surface.

Channels, which are executed continuously from the top dead center, operate as long as the pressure in the compression chamber is higher than the ambient pressure. Channels leading from the top dead center to nozzles guide the flow first from the compression chamber into the gas reservoir and, when the pressure difference is reversed, from the gas reservoir into the compression chamber. These two variants use the work in the dead volume for gas support and in the case of the second variant even to fill the gas reservoir for the bearing.

In the case of the second variant there is also the counterflow effect. The gas flow is counter to the movement over a large operating region of the piston travel. This allows the resulting varying friction coefficient to be utilized.

A third variant of the channels goes from the nozzles to the low-pressure side. A permanent flow is present here.

Further details and advantages of the invention will emerge from the description with figures which follows of exemplary embodiments based on the drawing in conjunction with the claims. In the drawing

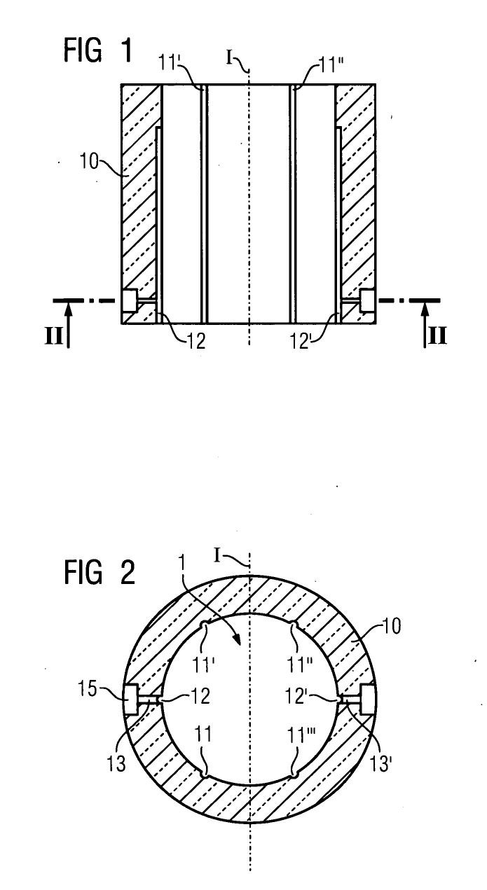

FIG. 1 shows a longitudinal section through a base element that can be used for the new gas bearing and

FIG. 2 shows a section along the line II-II in FIG. 1.

The two figures are described together below. The structure and function of a gas bearing with compression chamber and gas reservoir are assumed to be already known from the prior art.

The figures show a gas chamber 1 surrounded by a base element 10 in the form of a hollow cylinder with a cylinder axis I. The gas chamber 1 serves as a compression chamber for a piston (not shown in the figures). On the inner wall of the hollow cylinder 10, parallel to the cylinder axis I are four nozzle-free channels 11, 11′, 11″, 11″′ for supplying gas via the compression chamber. The four channels 11 to 11″′ are arranged on the inner wall of the hollow cylinder in such a manner that a rectangle is formed in the top view according to FIG. 2.

Two nozzle channels 12, 12′ are also present, connected to a gas reservoir 15 via nozzles 13, 13′.

The inner wall of the hollow cylinder 10 can be structured, to achieve a turbulent flow in the bearing gap, i.e. the gap between the inner wall and the piston, and to reduce the mass flow. The channels 11, 12 have a semi-circular cross section for this purpose.

In FIG. 1 the channels are shown straight. To achieve an optimum between path and flow resistance, the channels can also be executed as spiral-shaped or wave-shaped. Junctions of the channels are also possible.

In contrast to FIG. 1, the continuous channels can also be disposed on the piston wall.

The following advantages result with the described arrangement:
1) With the nozzle-free channels the gas of the dead volume is used without nozzles, i.e. in a manner tolerant to dirt, to guide the piston in the upper region (overpressure in the dead volume).
2) During the intake process, in other words at a compressive pressure lower than the nozzle pressure, the gas is routed via channels with at least one nozzle into the compression chamber, in other words in the counterflow. The counterflow technology produces a different friction coefficient from a flow in the movement direction. It is thus possible to operate with a smaller flow.
3) During the compression process gas continues to flow into the compression chamber with the piston movement, until the differential pressure becomes too small. The bearing is supplied from the compression chamber from this point.

1-13. (canceled)

14. A gas bearing comprising:
a base element having a hollow cylinder portion, the hollow cylinder portion delimiting an inner chamber in which a gas from a gas reservoir can be fed or from which a gas can be discharged and the inner chamber being operable as a compression chamber in which a piston can be movably supported, the base element including an inner face and a plurality of channels formed in the inner face of the base element, one group of channels being operable to supply gas via the inner chamber and another group of channels being connected to a gas reservoir.

15. The gas bearing as claimed in claim 14, wherein the gas bearing is operable to achieve a loss reduction capacity by guiding the gas in the channels.

16. The gas bearing as claimed in claim 14, wherein the gas bearing is configured to implement a counterflow principle in a manner to reduce a mass flow and to guide bearing gas back into the compression chamber.

17. The gas bearing as claimed in claim 14, wherein the gas bearing is configured to implement a counterflow principle in a manner to reduce a mass flow and to guide the bearing gas back into the gas reservoir.

18. The gas bearing as claimed in claim 14, wherein the gas bearing is configured to operate with a reduced number of nozzles via delivery of some gas along the one group of channels formed in the inner element.

19. The gas bearing as claimed in claim 14, wherein the gas bearing is configured to operate to produce a turbulent flow in a bearing gap vfa configuration of the channels and/or surfaces of the inner wall of the cylinder to reduce a mass flow.

20. The gas bearing as claimed in claim 18, wherein the gas channels have a semi-circular profile.

21. The gas bearing as claimed in claim 14, wherein the inner element has a cylinder axis and the gas channels extend substantially parallel to the cylinder axis.

22. The gas bearing as claimed in claim 14, wherein the gas channels are configured in a spiral shape or wave shape.

23. The gas bearing as claimed in claim 14, wherein the geometric shape of the base element in the form of a hollow cylinder and an associated piston is circular.

24. The gas bearing as claimed in claim 14, wherein the geometric shapes of the base element in the form of a hollow cylinder and an associated piston are angular, preferably, hexagonal or octagonal.

25. The gas bearing as claimed in claim 23, wherein the channels are disposed on a piston wall.
